(19) United States
(12) Patent Application Publication
(10) Pub. No.: US 2001/0004895 A1
(43) Pub. Date: Jun. 28, 2001

(54) Carbon dioxide absorbent for anesthesia apparatuses

(75) Inventor: Helmut Preiss, Bermatingen (DE)

Correspondence Address: EVENSON MCKEOWN EDWARDS AND LENAHAN, 1200 G STREET, SUITE 700, WASHINGTON, DC, 20005, US

(73) Assignee: ASTRIUM GmbH

(21) Appl. No.: 09/739,249

(22) Filed: Dec. 19, 2000

(30) Foreign Application Priority Data
Dec. 24, 1999 (DE) 199 63 066.6

(51) Int. Cl. A62B 7/10; A62B 23/02

(52) U.S. Cl. 128/205.28; 128/203.12

(57) ABSTRACT

A breathing lime for anaesthetic apparatuses made of a macroporous ion exchange resin having primary benzylamine groups.

### BACKGROUND AND SUMMARY OF INVENTION

This application claims the priority of German application No. 199 63 066.6, filed Dec. 24, 1999, the disclosure of which is expressly incorporated by reference herein.

The present invention relates to a breathing lime which is used as an absorbent for anesthesia apparatuses.

In anesthesia apparatuses, metabolically-produced carbon dioxide is withdrawn from the respiratory circulation by an absorbent, The absorbents used so far, which are generally called “breathing lime”, are expendable materials which must be replaced after being loaded with carbon dioxide. In addition, various events in clinical applications show that, in the case of known breathing limes, reactions may occur with several halogenated narcotics which harm the patient (German Patent Document DE 197 40 736 A1). Thus, the formation of carbon monoxide and Compound A was detected.

It is therefore an object of the present invention to provide a breathing lime which, after a use in the anaesthesia apparatus, can be reused as a result of a regeneration. In addition, the breathing lime should release no substances harmful to the patient when halogenated narcotics are used.

The breathing lime for anaesthesia apparatuses according to the present invention comprises as essential components a macroporous ion exchange resin with primary benzylamine groups.

The ion exchange resin according to the present invention has a very good binding property for gaseous carbon dioxide.

Another significant advantage of the absorbent according to the present invention is the fact that it can be regenerated. When the receiving capacity of the absorbent is exhausted, it can be taken out of the anaesthesia apparatus and regenerated at a different location. The regeneration can take place with the use of steam at a slightly increased pressure or under vacuum conditions or at a slightly raised temperature (approximately 30 to 40° C.). Subsequently, the regenerated breathing lime can be placed back in the anaesthesia apparatus.

When the breathing lime according to the present invention is used, no reactions with halogenated narcotics occur that are harmful to the patient.

Materials that are particularly suitable for the breathing lime are produced according to the process described in German Patent Document DE 25 19 244 C3 (corresponding U.S. Pat. No. 4,077,918 which is incorporated by reference herein in its entirety).

The macroporous ion exchange resin may comprise styrene polymers cross-linked with distyrene, which ion exchange resin contains primary benzylamine groups as functional groups.

In a preferred embodiment, the production of the ion exchange resin takes place by the reaction of the styrene polymers cross-linked with divinylbenzene (vinylstyrene) in the presence of swelling agents and a subsequent saponification, in which case the polymers are reacted with a bis(dicarbonimidoalkyl)ether in the presence of sulfur trioxide. By the saponification operation, the benzylamine groups arc built into the matrix.

Preferred parameters of this ion exchange resin according to the present invention are;

Degree of cross-linkage 2 to 10%;

concentration of the functional groups between 2 and 3 mol/l;

porosity between 20 and 30%; and

average pore diameter between 200 and 300 Angstroms.

For the purpose of a clarification, it is pointed out that, despite the name “breathing lime”, the absorbent according to the present invention does not have to have a lime-type consistency. The term “breathing lime” is retained in order to ensure a clear definition of the usage purpose of the substance according to the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram for using the breathing lime according to the present invention in an anaesthesia apparatus; and

FIG. 2 is a schematic diagram for regenerating the breathing lime.

### DETAILED DESCRIPTION OF THE DRAWINGS

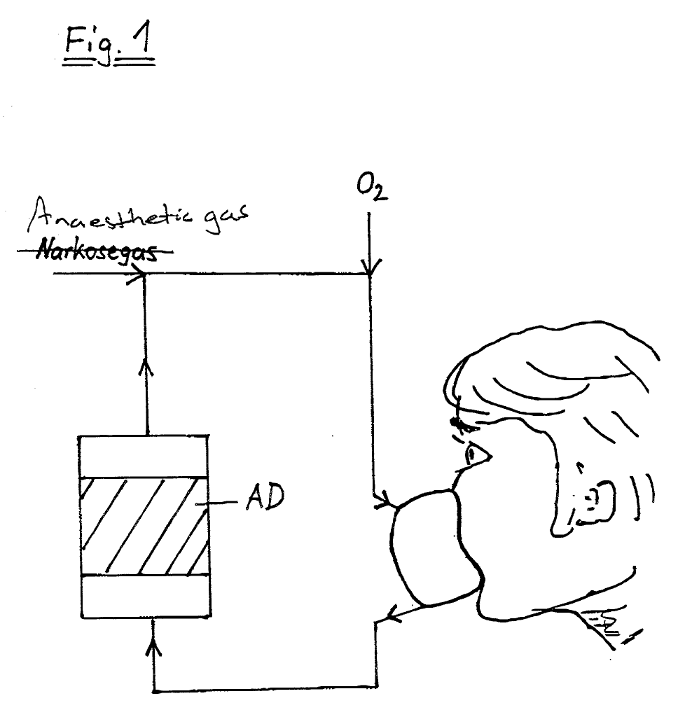

FIG. 1 is a schematic diagram for using the breathing lime according to the present invention in an anaesthesia apparatus. The absorbent AD according to the present invention is charged into the respiratory circulation of the anaesthesia apparatus at the same location as the conventional breathing lime. Oxygen and an anaesthetic gas are supplied to the patient. The patient's breathing air, which, in particular, contains CO₂, is guided to the adsorbent AD, on which it is absorbed.

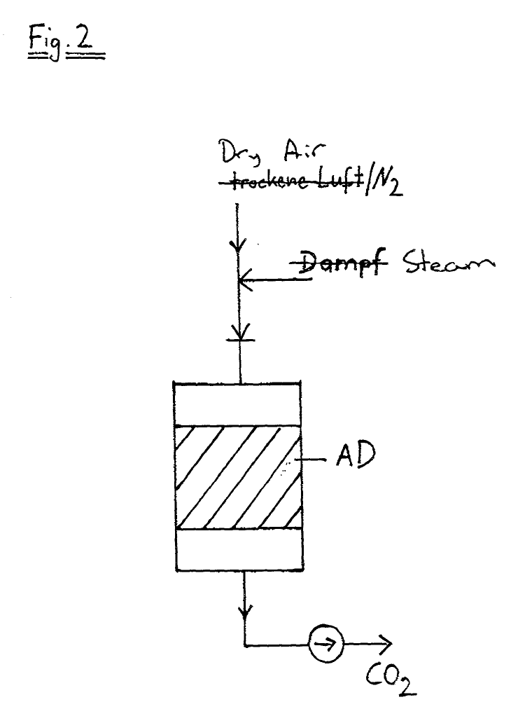

When the permissible CO₂ concentration has been reached, the loaded breathing lime is replaced by another receptacle with regenerated breathing lime. The loaded breathing lime is regenerated at a different location, as illustrated in an example in FIG. 2. The regeneration can take place at atmospheric conditions, but can also be carried out by applying a vacuum as well as by supplying heat. In the illustrated example, the regeneration takes place by feeding water vapor. After the CO₂ has been expelled, the breathing lime is cooled with dry air andjor nitrogen and is thus brought to the residual moisture desirable for the use in the anaesthesia apparatus.

After the closing of the incoming-air opening and the outgoing-air opening of the receptacle, the regenerative breathing lime will be ready to be reused.

As illustrated in FIG. 2, the regenerating of the absorbent can be carried out by means of the simplest devices. Thus, it is possible to carry out the regeneration directly at the site; thus, for example, in the hospital.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A breathing lime for anaesthesia apparatus comprising a macroporous ion exchange resin having primary benzylamine groups.

2. A breathing lime according to claim 1, wherein the ion exchange resin comprises a styrene polymer cross-linked with divinylbenzene.

3. A breathing lime according to claim 2, wherein the degree of cross-linkage of the ion exchange resin is 2 to 10%.

4. A breathing lime according to claim 2, wherein a porosity of the ion exchange resin is between 20 and 30%.

5. A breathing lime according to claim 2, wherein an average pore diameter of the ion exchange resin is between 200 and 300 Angstroms.

6. A breathing lime according to claim 2, wherein a concentration of functional groups of the ion exchange resin is between 2 and 3 mol/l.

7. An anaesthesia apparatus comprising the breathing lime of claim 1.

8. A method of removing carbon dioxide produced by a person connected to a anaesthesia apparatus, comprising:
collecting carbon dioxide produced by a person connected to an anaesthesia apparatus with a breathing lime comprising a macroporous ion exchange resin having primary benzylamine groups; and
once the breathing lime has absorbed a limit for carbon dioxide, substituting a new breathing lime for the carbon-dioxide-loaded breathing lime.
